(19) United States
(12) Patent Application Publication
(10) Pub. No.: US 2014/0279802 A1
(43) Pub. Date: Sep. 18, 2014

(54) METHODS AND SYSTEMS FOR PROPAGATING INFORMATION IN COLLABORATIVE DECISION-MAKING

(71) Applicants: GENERAL ELECTRIC COMPANY, Schenectady, NY (US); GE AVIATION SYSTEMS LLC, Grand Rapids, MI (US); GE AVIATION SYSTEMS LIMITED, Cheltenham (GB)

(72) Inventors: Mark Thomas Harrington, Tewkesbury (GB); Bernhard Joseph Scholz, Ballston Lake, NY (US); Jonathan Mark Dunsdon, Glenville, NY (US); Tony Cecil Ramsaroop, Grand Rapids, MI (US); Rajesh V. Subbu, Clifton Park, NY (US); Maria Louise Watson, Alresford (GB)

(73) Assignees: GENERAL ELECTRIC COMPANY, Schenectady, NY (US); GE AVIATION SYSTEMS LIMITED, Cheltenham (GB); GE AVIATION SYSTEMS LLC, Grand Rapids, MI (US)

(21) Appl. No.: 13/841,786

(22) Filed: Mar. 15, 2013

(51) Int. Cl. G06N 5/02

(52) U.S. Cl. CPC G06N 5/02
USPC 706/47

(57) ABSTRACT

A computer includes a processor and a memory device. The computer is configured to a) receive decision-making criteria from at least one of at least a portion of a plurality of agents associated with a plurality of agent devices, the memory device, and a user, b) generate valid decision combinations using at least a portion of received decision-making criteria, c) transmit, to the plurality of agents, valid decision combinations, d) receive, from a deciding agent, a decision, and e) constrain, using the received decision, valid decision combinations. The computer is configured to f) return to c) until determining that no more decisions can be received. The computer is configured to g) transmit a final decision set to the plurality of agents upon determining that no more decisions can be received. The final decision set represents a complete combination of decisions including at least a portion of received decisions.

### BACKGROUND

The field of the disclosure relates generally to computer-implemented programs and, more particularly, to a computer-implemented system for propagating information in collaborative decision-making.

Many known systems involve decision-making by several entities. In many cases, decisions made by one entity may affect another entity and alter, expand, or constrain the options for decisions made by other entities. Such relationships between entities may be characterized as interdependent. Interdependent decisions are made more efficient through collaborative decision-making where decisions are not made in isolation. Collaborative decision-making allows for considerations of multiple entities to be factored into each and all of the collaborative decisions.

Many known methods of collaborative decision-making involve at least some automation. Such methods of collaborative decision-making involve at least some manual methods and one-to-one communications between human decision makers in order to reach a decision consensus. Such methods of collaborative decision-making may have points of instability when a change occurs in a system and affects operations. Points of instability represent times when the decision-making options and results change substantially for many entities within the system. System changes may suddenly shift the decisions available, individually and collectively, to entities in the system.

Many known methods of collaborative decision-making also involve outcome preferences. Outcome preferences are the preferred outcomes for either individual entities in the system, for groups of entities, or for all entities in the system. Outcome preferences may exist at level of the system or of individual entities in the system. Due to the interdependency of decisions, a particular decision may impact the ability of system or individual entity preferences to be satisfied.

### BRIEF DESCRIPTION

In one aspect, a network-based computer-implemented system is provided. The system includes a plurality of agent devices associated with a plurality of agents. The system also includes a computing device in networked communication with the plurality of agent devices. The computing device includes a processor. The computing device also includes a memory device coupled to the processor. The computing device is configured to a) receive decision-making criteria from at least one of at least a portion of the plurality of agents, the memory device, and a user. The computing device is also configured to b) generate valid decision combinations using at least a portion of received decision-making criteria. The computing device is further configured to c) transmit, to the plurality of agents, valid decision combinations. The computing device is additionally configured to d) receive, from a deciding agent, a decision. The computing device is also configured to e) constrain, using the received decision, valid decision combinations. The computing device is further configured to f) return to c) until determining that no more decisions can be received. The computing device is additionally configured to g) transmit a final decision set to the plurality of agents upon determining that no more decisions can be received. The final decision set represents a complete combination of decisions including at least a portion of received decisions.

In a further aspect, a computer-based method is provided. The computer-based method is performed by a computing device. The computing device includes a processor. The computing device also includes a memory device coupled to the processor. The method includes a) receiving decision-making criteria from at least one of at least a portion of a plurality of agents associated with a plurality of agent devices, the memory device, and a user. The method also includes b) generating valid decision combinations using at least a portion of received decision-making criteria. The method further includes c) transmitting, to the plurality of agents, valid decision combinations. The method additionally includes d) receiving, from a deciding agent, a decision. The method also includes e) constraining, using the received decision, valid decision combinations. The method further includes f) returning to c) until determining that no more decisions can be received. The method additionally includes g) transmitting a final decision set to the plurality of agents upon determining that no more decisions can be received. The final decision set represents a complete combination of decisions including at least a portion of received decisions.

In another aspect, a computer is provided. The computer includes a processor. The computer also includes a memory device coupled to the processor. The computer is configured to a) receive decision-making criteria from at least one of at least a portion of a plurality of agents associated with a plurality of agent devices, the memory device, and a user. The computer is also configured to b) generate valid decision combinations using at least a portion of received decision-making criteria. The computer is further configured to c) transmit, to the plurality of agents, valid decision combinations. The computer is additionally configured to d) receive, from a deciding agent, a decision. The computer is also configured to e) constrain, using the received decision, valid decision combinations. The computer is further configured to f) return to c) until determining that no more decisions can be received. The computer is additionally configured to g) transmit a final decision set to the plurality of agents upon determining that no more decisions can be received. The final decision set represents a complete combination of decisions including at least a portion of received decisions.

### DRAWINGS

These and other features, aspects, and advantages will become better understood when the following detailed description is read with reference to the accompanying drawings in which like characters represent like parts throughout the drawings, wherein:

FIG. 1 is a block diagram of an exemplary computing device that may be used for propagating information in collaborative decision-making;

FIG. 2 is a schematic view of an exemplary high-level computer-implemented system for propagating information in collaborative decision-making that may be used with the computing device shown in FIG. 1;

FIG. 3 is flow chart of an exemplary process for propagating information in collaborative decision-making using the computer-implemented system shown in FIG. 2; and

FIG. 4 is a simplified flow chart of the overall method for propagating information in collaborative decision-making using the computer-implemented system shown in FIG. 2.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “entity” and related terms, e.g., “entities,” refers to individual participants in the system described. Also, as used herein, entities are capable of making decisions which may affect outcomes for other entities, and, therefore, for the system as a whole. Additionally, as used herein, entities are associated with agent devices and agents, described below.

As used herein, the term “outcome preference” refers to conditions are preferable to entities and/or the system when such conditions arise as a consequence of decisions made by entities. Therefore, outcome preferences reflect the individual and collective results which entities seek as they make decisions in the system. Also, as used herein, outcome preferences are used to identify decision combinations which may be beneficial to an entity, entities, and/or the system.

As used herein, the terms “software” and “firmware” are interchangeable, and include any computer program stored in memory for execution by devices that include, without limitation, mobile devices, clusters, personal computers, workstations, clients, and servers.

As used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

As used herein, the term “computer” and related terms, e.g., “computing device”, are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

As used herein, the term “automated” and related terms, e.g., “automatic,” refers to the ability to accomplish a task without any additional input. Also, as used herein, the decision processing is automated using the systems and methods described.

As used herein, the term “agent” and related terms, e.g., “software agent,” refers to a computer program that acts for another program in a relationship of agency, or on behalf of the other program. Also, as used herein, agents are self-activating, context-sensitive, capable of communicating with other agents, users, or central programs, require no external input from users, and are capable of initiating secondary tasks. Also, as used herein, agents are used within agent devices to collaborate with a computing device for the purpose of collaborative decision-making.

As used herein, the term “agent device” refers to any device capable of hosting an agent for the purpose of collaborative decision-making. Agent devices may be physical devices or virtual devices. In a particular system, agent devices may be homogeneous or heterogeneous. Also, as used herein, an agent device has the ability to communicate with other agent devices and a computing device for at least the purpose of collaborative decision-making.

As used herein, the term “collaborative” and related terms, e.g., “collaborative decision-making,” refers to the use of multiple entities or agents to work in conjunction to allow the computer-implemented methods and systems to determine decision combinations for the agents. Also, as used herein, the methods and systems described use a collaborative approach to pool decision options, decision relationships, and decision preferences, resolve these with simulated outcomes, and identify decision combinations that are valid and preferred in order to propagate decisions to agents which meet the interests of the system and the agents.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The computer-implemented systems and methods described herein provide an efficient approach for propagating information in collaborative decision-making. The systems and methods create such efficiency by collecting data regarding agent decision preferences, agent decision options, and agent decision relationships in order to effectively create a model by which decisions can be made which provide an enhanced benefit to the system and at least multiple entities. The embodiments described herein reduce communication and logistics costs associated with poorly timed or coordinated decisions. Specifically, by collecting data described above and assessing outcomes for all entities, decision-making is coordinated for all connected entities with reduced latency. Therefore, the issues which may arise without such an approach are minimized. Also, the methods and systems described herein increase the utilization of resources controlled in decision-making. Specifically, by taking such a coordinated approach with an attempt to enhance utility derived by all entities, resources utilization is enhanced for a greater number of entities. Further, the methods and systems described herein improve capital and human resource expenditure through more coordinated activity. Specifically, by focusing on all entities involved in decision-making, decisions which may affect one group positively while hindering a greater number of entities are minimized.

FIG. 1 is a block diagram of an exemplary computing device 105 that may be used for propagating information in collaborative decision-making. Computing device 105 includes a memory device 110 and a processor 115 operatively coupled to memory device 110 for executing instructions. In the exemplary embodiment, computing device 105 includes a single processor 115 and a single memory device 110. In alternative embodiments, computing device 105 may include a plurality of processors 115 and/or a plurality of memory devices 110. In some embodiments, executable instructions are stored in memory device 110. Computing device 105 is configurable to perform one or more operations described herein by programming processor 115. For example, processor 115 may be programmed by encoding an operation as one or more executable instructions and providing the executable instructions in memory device 110.

In the exemplary embodiment, memory device 110 is one or more devices that enable storage and retrieval of information such as executable instructions and/or other data. Memory device 110 may include one or more tangible, non-transitory computer-readable media, such as, without limitation, random access memory (RAM), dynamic random access memory (DRAM), static random access memory (SRAM), a solid state disk, a hard disk, read-only memory (ROM), erasable programmable ROM (EPROM), electrically erasable programmable ROM (EEPROM), and/or non-volatile RAM (NVRAM) memory. The above memory types are exemplary only, and are thus not limiting as to the types of memory usable for storage of a computer program.

Memory device 110 may be configured to store operational data including, without limitation, decisions, valid decision combinations, agent priority rankings, agent conditional priority rankings, decision-making rules, agent decision options, agent decision relationships, agent decision preferences, historic decision outcomes, simulated decision outcomes, valid decision combinations, and preferred decision combinations (all discussed further below). In some embodiments, processor 115 removes or “purges” data from memory device 110 based on the age of the data. For example, processor 115 may overwrite previously recorded and stored data associated with a subsequent time and/or event. In addition, or alternatively, processor 115 may remove data that exceeds a predetermined time interval. Also, memory device 110 includes, without limitation, sufficient data, algorithms, and commands to facilitate operation of the computer-implemented system (not shown in FIG. 1).

In some embodiments, computing device 105 includes a user input interface 130. In the exemplary embodiment, user input interface 130 is coupled to processor 115 and receives input from user 125. User input interface 130 may include, without limitation, a keyboard, a pointing device, a mouse, a stylus, a touch sensitive panel, including, e.g., without limitation, a touch pad or a touch screen, and/or an audio input interface, including, e.g., without limitation, a microphone. A single component, such as a touch screen, may function as both a display device of presentation interface 120 and user input interface 130.

A communication interface 135 is coupled to processor 115 and is configured to be coupled in communication with one or more other devices, such as a sensor or another computing device 105 with one or more agent devices (not shown in FIG. 1), and to perform input and output operations with respect to such devices. For example, communication interface 135 may include, without limitation, a wired network adapter, a wireless network adapter, a mobile telecommunications adapter, a serial communication adapter, and/or a parallel communication adapter. Communication interface 135 may receive data from and/or transmit data to one or more remote devices. For example, a communication interface 135 of one computing device 105 may transmit an alarm to communication interface 135 of another computing device 105. Communications interface 135 facilitates machine-to-machine communications, i.e., acts as a machine-to-machine interface.

Presentation interface 120 and/or communication interface 135 are both capable of providing information suitable for use with the methods described herein, e.g., to user 125 or another device. Accordingly, presentation interface 120 and communication interface 135 may be referred to as output devices. Similarly, user input interface 130 and communication interface 135 are capable of receiving information suitable for use with the methods described herein and may be referred to as input devices. In the exemplary embodiment, presentation interface 120 is used to visualize the data including, without limitation, decisions, valid decision combinations, agent priority rankings, agent conditional priority rankings, decision-making rules, agent decision options, agent decision relationships, agent decision preferences, historic decision outcomes, assessed decision outcomes, valid decision combinations, and preferred decision combinations. In at least some embodiments, visualizing assessed decision outcomes, historic decision outcomes, and valid decision combinations includes displaying this data in conjunction with an associated ranking for key performance indicators (discussed further below). Once such data is visualized user 125 may use user input interface 130 to execute tasks including, without limitation, prioritizing decision combinations, and communicating with agents (all discussed further below). Such tasks may include the use of additional software which may facilitate such functions.

In the exemplary embodiment, computing device 105 is an exemplary embodiment of a computing device to be used in an exemplary high-level computer-implemented system for propagating information in collaborative decision-making (not shown in FIG. 1). In at least some other embodiments, computing device 105 is also an exemplary embodiment of agent devices (not shown in FIG. 1) and other devices (not shown) used for propagating information in collaborative decision-making. In most embodiments, computing device 105 at least illustrates the primary design of such other devices.

FIG. 2 is an exemplary high-level computer-implemented system 200 for propagating information in collaborative decision-making that may be used with computing device 105. System 200 includes computing device 105 in communication with a plurality of agents 230 hosted on a plurality of agent devices 231. Computing device 105 includes memory device 110 coupled to processor 115. In at least some embodiments, computing device 105 also includes storage device 220 which is coupled to processor 115 and memory device 110. Storage device 220 represents a device supplemental to memory device 110 that may store information related to the methods and systems described herein. Storage device 220 may be directly accessible by processor 115 of computing device 105 or may alternately be accessible via communication interface 135.

In at least some embodiments, computing device 105 includes database 225. Database 225 may be any organized structure capable of representing information related to the methods and systems described including, without limitation, a relational model, an object model, an object relational model, a graph database, or an entity-relationship model. Database 225 may also be used to store historical data relevant to assessments and outcomes of previous collaborative decisions.

In at least some embodiments, user 125 interacts with computing device 105 in order to facilitate the collaborative decision-making systems and methods described. User 125 may interact using presentation interface 120 (shown in FIG. 1) and user input interface 130 (shown in FIG. 1).

Agents 230 are associated with a plurality of agent devices 231. In the exemplary embodiment, there are six agents 230 and six agent devices 231 shown. However, system 200 may include any number of agents 230 and agent devices 231. Agents 230 represent software programs that facilitate collection, processing, display, coordination, and dissemination of information used in collaborative decision-making. Agents 230 may vary depending upon the limitations and features of agent devices 231. However, all agents 230 are capable of collecting, processing, and transmitting data 235, using associated agent device 231, to computing device 105. In at least some embodiments, agent devices 231 allow for user 125 to interact with agent devices 231 by, without limitation, transmitting, receiving, prompting, processing, and displaying data.

In the exemplary embodiment, agent devices 231 represent devices capable of hosting agents 230. Agent devices 231 may be physical devices or virtual devices. In the exemplary embodiment agent devices 231 are physical computing devices with an architecture similar to computing device 105. Alternately, any architecture may be used for agent device 231 which allows for hosting of agent 230 and communication with computing device 105. Agent devices 231 may communicate with computing device 105 using wired network communication, wireless network communication, or any other communication method or protocol which may reliably transmit data 235 between agent devices 231 and computing device 105.

In operation, agent devices 231 are used for distinct processes. For example, system 200 may be used to coordinate the activities of an airline in an airport. In this example, a first agent device 231 may be tied to a ticketing program while a second agent device 231 is tied to a check-in program. Accordingly, each agent device 231 is associated with a particular entity performing a particular task. Agent 230 may collect data 235 (described in detail below) present on agent device 231 and transmit it as data 235 to computing device 105. Collecting data 235 by agent 230 represents the agent software program running on agent device 231 collecting information described above as decision-making criteria (not shown in FIG. 2) which may be relevant to collaborative decision-making. Alternately, decision-making criteria may be transmitted by user 125 using user input interface 130 (shown in FIG. 1) or received from memory device 110.

Computing device 105 receives decision-making criteria as either data 235, input from user 125, or data stored on memory device 110. Computing device 105 generates valid decision combinations (described in detail below) representing all possible decisions that may be made by all agents 230 and associated agent devices 231. Computing device 105 transmits valid decision combinations to the plurality of agents 230. Valid decision combinations are transmitted as data 235.

At least one agent 230 makes a decision (described in detail below) and transmits it as data 235 to computing device 105. In the exemplary embodiment, each agent 230 acts in serial and transmits a decision one at a time. In other embodiments, multiple agents 230 transmit decisions to computing device 105.

Computing device 105 constrains valid decision combinations using the received decision or decisions. Until no more decisions can be received, computing device 105 transmits valid decision combinations (now constrained) to the plurality of agents 230. Once no more decisions can be received, computing device 105 transmits a final decision set (described in detail below) to the plurality of agents. The final decision set represents a complete combination of decisions including at least a portion of received decisions.

FIG. 3 is flow chart of an exemplary process 300 for propagating information in collaborative decision-making using the computer-implemented system 200 (shown in FIG. 2). Process 300 is initiated by computing device 105 receiving decision-making criteria 305 from at least one of at least a portion of agents 230 associated with agent devices 231, memory device 110, and user 125. Decision-making criteria 305 includes at least some of agent decision options associated with agents 230, agent decision relationships associated with agents 230, agent decision preferences associated with agents 230, and decision-making rules.

Decision-making criteria 305 may include agent decision options. Agent decision options represent the possible choices that agent 230 may have, given no other limitations. In one example, agent 230 may be responsible for designating seat assignments for an oversold airplane flight. Therefore, agent 230 will have agent decision options associated with all possible seat assignment combinations for passengers on the airplane flight.

Also, decision-making criteria 305 may include agent decision relationships. Agent decision relationships represent the impact that a particular decision may have on other agents 230. Continuing the example above, agent 230 responsible for seat assignments for an oversold airplane flight will impact other agents 230. For instance, agents 230 associated with some additional flights will be impacted because passengers will potentially use their flights. Alternately, agents 230 associated with flight scheduling may relate to agents 230 associated with maintenance because a particular flight schedule may obviate maintenance.

Further, decision-making criteria 305 may include agent decision preferences. Agent decision preferences represent the preferred outcome from the perspective of an entity associated with agent 230. Continuing the airplane seating example, agent 230 may have a preference for a particular grouping of passengers to be assigned to the flight because of grouping requirements of the passengers. A second example may illustrate agent decision preferences further. A family may attempt to go on a vacation. Each family member is allowed to make a choice reflecting exactly one of the vacation timing, the vacation location, the vacation budget, and the vacation amenities. Although each family member makes each choice separately, preferences for each family member may be understood and applied to the decisions of others. For instance a trip across the world may be desired by one family member while another prefers a four day trip. Awareness of the joint preferences may prevent poorly coordinated decisions.

Moreover, decision-making criteria 305 may include decision-making rules. Decision-making rules represent guiding requirements for the process 300 which constrain all decisions. Decision-making rules may be, without limitation, legal requirements, physical or operational requirements, business requirements, particular prioritizations of decisions for agents 230, and special decision-making rules for given conditions. In some cases, a first agent 230 may have a special priority over a second agent 230. In such cases, even if second agent 230 sends a decision (discussed further below) before first agent 230, first agent 230 will take priority. In other cases, legal, physical, or logistical requirements may render a particular decision by agent 230 invalid. In further cases, decision-making rules may be altered or substituted because of a change in conditions affecting process 300.

Decision-making criteria 305 may include portions of decision-making rules, agent decision preferences, agent decision relationships, and agent decision options. Decision-making criteria 305 may be received from agents 230, memory device 110, and user 125. In all cases, decision-making criteria 305 must be sufficient to allow for generating valid decision combinations 310. In the case of insufficient decision-making criteria 305, decision preferences will rank valid decision combinations 310.

Valid decision combinations 310 represent all possible combinations that may be made by agents 230 given decision-making criteria 305. For example, decision-making criteria 305 may refer to certain agent decision options while containing decision-making rules which preclude those agent decision options. In this example, valid decision combinations 310 would not contain such pre-empted agent decision options.

Valid decision combinations 310 are transmitted to agents 230 as data 235 (shown in FIG. 2). To continue the example of the oversold airplane, computing device 105 may send valid decision combinations 310 to agent 230 containing all valid potential seating assignment configurations. In at least some embodiments, valid decision combinations 310 are sent in conjunction with an assessment of outcomes for each decision combination. In a first example, the assessment of outcomes may represent a probability distribution of outcomes for each agent 230 in each assessment. In this example, the assessment of outcomes cannot provide a certain prediction but rather provides a profile of probability adjusted outcomes. Agent 230 can then evaluate the potential impact of each particular decision combination on other agents 230.

The assessment of outcomes may also represent outcomes of decisions ranked by at least one key performance indicator. For example, the assessment of outcomes may include a metric reflective of the impact of particular decisions available to agent 230. The metric will reflect considerations which are significant to agent 230, groups of agents 230, or system 200 (shown in FIG. 2).

Agents 230 may then select from valid decision combinations 310 to create decision 315. Decision 315 reflects a particular decision for agent 230. Decision 315 must be contained within valid decision combinations 310. In the oversold flight example, agent 230 selects one seating assignment for the flight. In alternative embodiments, agent 230 may determine that several seating assignments are of similar benefit to agent 230. Therefore agent 230 may prefer several decisions 315 equally to one another. Agent 230 may include several alternatives in decision 315. As discussed below, computing device 105 may then opt for a particular decision 315 based upon impact to other agents 230.

In some embodiments, agent 230 may be responsible for making several distinct decisions 315. In these embodiments, the distinct decisions 315 are not substitutable for one another (as described above) but distinct from one another. For example, an operations agent 230 may determine both the time of departure for a flight and the type of aircraft to be used, thus defining the passenger seating capacity, when trying to recover from the shortage of an aircraft resource due to, for example, mechanical maintenance. In these embodiments, agent 230 may make multiple decisions 315.

Agent 230 transmits decision 315 to computing device 105. Computing device 105 uses decision 315 to constrain valid decision combinations 310. Constraining valid decision combinations 310 represents using received decisions 315 to remove all valid decision combinations 310 which are no longer possible given received decision 315. For example, if a particular decision 315 from agent 230 schedules a maintenance event for a plane at an airport which takes two hours, all valid decision combinations 310 allowing for flight departure within two hours will be constrained, and therefore removed.

In some cases, multiple decisions 315 may be received from multiple agents 230 simultaneously. In some cases, decisions 315 may be processed simultaneously at computing device 105. However, in some cases, decisions 315 may be impossible to simultaneously process. In one case, computing device 105 may not have system resources available for such computation.

In another case, decisions 315 may be mutually exclusive. For example, a first agent 230 may make a first decision 315 for a flight to receive repairs which will take several hours. Simultaneously, a second agent 230 makes a second decision 315 for a flight to immediately depart. These decisions 315 cannot be processed together and one must obtain priority. Computing device 105 may use several methods for resolving such priority. Computing device 105 may resolve decisions 315 using timing methods. For instance, computing device 105 may track, without limitation, timestamps associated with receipt of decision 315 at computing device 105 or timestamps associated with sending of decision 315 from agents 230. Alternately, computing device 105 may use any timing method which may resolve the priority of decisions 315. Computing device 105 may alternately assign a priority ranking to agents 230. The priority ranking may be used to designate which agents 230 will receive priority in such situations. Computing device 105 may also assign a priority ranking to agents 230 given a system condition. A priority ranking for agents 230 given a system condition reflects the possibility that priorities may shift in certain situations. For example, during a weather phenomenon such as a snowstorm maintenance activities may receive particular priority.

After computing device 105 constrains valid decision combinations 310 using decisions 315, valid decision combinations 310 are sent once again to agents 230. This cycle will repeat until no more decisions 315 can be received by computing device 105. In the exemplary embodiment, the determination that no more decisions 315 can be received represents the fact that all agents 230 have made valid decisions 315. In alternative embodiments, none of received valid decision combinations 310 are acceptable to at least one agent 230 and the at least one agent 230 transmits an indication of rejection 314 to computing device 105 which restarts process 300.

In another example, a first agent 230 may create decisions 315 which cause computing device 105 to constrain to three valid decision combinations 310. A second agent 230 may create decisions 315 which then cause computing device 105 to constrain to two valid decision combinations 310. The eliminated decision combination caused by decisions 315 made by second agent 230 may have been the only acceptable decision combination for a third agent 230 which had previously responded with several decisions 315 but subsequently faced a change in conditions. In this example, third agent 230 may transmit an indication of rejection 314 to computing device 105 and thereby restart process 300.

In a further example, a first agent 230 associated with an airline maintenance crew at a particular location may want to repair a first aircraft and declare the aircraft unavailable for service. The flights are organized accordingly. A second agent 230 associated with operations requires an extra aircraft to cover for flights because the first aircraft is out of service. Second agent 230 therefore selects a second aircraft. Simultaneously, bad weather closes an airport and leaves several aircrafts grounded including the second aircraft. When second agent 230 receives valid decision combinations 310 or a final decision set 320 (discussed further below), the second aircraft is no longer available even though this was not recognized when computing device 105 generated valid decision combinations 310. Second agent 230 will transmit an indication of rejection 314 to computing device 105, causing a restart of process 300 with updates to decision-making criteria 305. In at least one case, restarting process 300 may cause the repair of the first aircraft to be postponed.

In alternative embodiments, decisions 315 must be made under time constraints. In such conditions, the determination that no more decisions 315 can be received represents the fact that time has run out. In a first example, decisions 315 have been made by a quorum of agents 230 and a first critical time event has occurred. In this example, the quorum of agents 230 represents the minimal acceptable level of agent input. The quorum of agents 230 may represent any portion, fraction, or number of agents 230 that are adequate to allow for system 200 to make a final decision set 320. In some examples, the quorum of agents 230 may require that specific agents 230 provide decisions 315. The first critical time event represents a warning time where there system 200 may not have adequate time to wait for additional decisions 315. Definitions for the first critical time event and quorum of agents 230 may be received from memory device 110, user 125, database 225, storage device 220, agents 230, or any combination thereof. Decisions 315 which have not been made by agents 230 that have not decided can be determined by any method which provides valid decisions 315 including, without limitation, using historic stored decisions 315, ranking optimal decisions 315 by key performance indicators and picking the highest ranked, and using system defaults.

In a second example, decisions 315 have not been made by a quorum of agents 230 but a second critical time event has passed. The second critical time event represents a crucial time event which obviates taking further time to receive decisions 315 from agents 230. In this example, decisions 315 which have not been made by agents 230 that have not decided can be determined by any method which provides valid decisions 315 including, without limitation, using historic stored decisions 315, ranking optimal decisions 315 by key performance indicators and picking the highest ranked, and using system defaults.

Finally, once all decisions 315 have been made, computing device 105 transmits final decision set 320 to all agents 230. Final decision set 320 262550-1 represents the final decisions 315 associated with all agents 230. In some cases, as discussed above, decisions 315 may not be made by agents 230. In the oversold airplane example, final decision set 320 represents potential future actions to be taken by agents 230. In at least some embodiments, agents 230 may elect to override at least a portion of decisions 315.

In at least some examples, it may not be possible to create a final decision set 320 and send the final decision set 320 to agents 230. In a first example, conditions may have changed which prevent at least some decisions 315 from being valid. For example, a massive snowstorm may ground all planes at an airport and preclude decisions 315 which assumed no snowstorm. In a second example, constraining valid decision combinations 310 may lead to no valid decision combinations 310. More specifically, a particular decision 315 may preclude any other decision 315 from any other agent 230 given decision-making criteria 305. In these examples, process 300 will start from the beginning. Restarting process 300 may include using information from the previous process 300 to enhance the efficiency or effectiveness of the next round of decisions 315.

FIG. 4 is a simplified flow chart of method 400 for propagating information in collaborative decision-making using the computer-implemented system 200 (shown in FIG. 2). Method 400 is performed by computing device 105 (shown in FIG. 2). Computing device 105 receives 410 decision-making criteria from at least one of at least a portion of a plurality of agents associated with a plurality of agent devices, the memory device, and a user. Receiving 410 represents computing device 105 receiving decision-making criteria 305 (shown in FIG. 3) from agent devices 231 (shown in FIG. 2). Decision-making criteria 305 includes agent decision options, agent decision relationships, agent decision preferences, and decision-making rules.

Computing device 105 also generates 415 valid decision combinations. Generating 415 represents creating valid decision combinations 310 using at least a portion of received decision-making criteria 305.

Computing device 105 further transmits 420 valid decision combinations to a plurality of agents. Transmitting 420 represents sending valid decision combinations 310 to agents 230.

Computing device 105 additionally receives 425 a decision from a deciding agent. Receiving 425 represents computing device 105 receiving decision 315 (shown in FIG. 3) from agent 230. As discussed above, decision 315 may include a plurality of decisions 315 and multiple agents 230 may transmit decisions 315 simultaneously.

Computing device 105 further constrains 430 valid decision combinations using the received decision. Constraining 430 represents reducing or simplifying valid decision combinations 310 based upon received decisions 315.

Computing device 105 also determines 435 that no more decisions can be received. Determining 435 represents computing device 105 either receiving valid decisions 315 from all agents 230, receiving decisions 315 from a quorum of agents 230 after a first critical time event, or experiencing a second critical time event. If computing device 105 determines 435 more decisions 315 can be received, computing device 105 returns to transmitting 420.

If computing device 105 determines 435 no more decisions 315 can be received, computing device 105 transmits 440 a final decision set to the plurality of agents. Transmitting 440 represents sending final decision set 320 (shown in FIG. 3) to agents 230.

The above-described computer-implemented systems and methods provide an efficient approach for propagating information in collaborative decision-making. The systems and methods create such efficiency by collecting data regarding agent decision preferences, agent decision options, agent decision relationships, and decision-making rules in order to effectively create a model by which decisions can be made which provide an enhanced benefit to the system and at least multiple entities.

The embodiments described herein reduce communication and logistics costs associated with poorly timed or coordinated decisions. Specifically, by collecting data described above and simulating outcomes for all entities, decision-making is coordinated for all connected entities with no latency. Therefore, the issues which may arise without such an approach are minimized. Also, the methods and systems described herein increase the utilization of resources controlled in decision-making. Specifically, by taking such a coordinated approach with an attempt to enhance utility derived by all entities, resources utilization is enhanced for a greater number of entities. Further, the methods and systems described herein improve capital and human resource expenditure through enhanced coordinated activities. Specifically, by focusing on all entities involved in decision-making, decisions which may affect one group positively while hindering a greater number of entities are minimized.

An exemplary technical effect of the methods and computer-implemented systems described herein includes at least one of (a) increased speed of decision-making in collaborative decision-making environments; (b) enhanced quality of decision-making by ranking decisions by satisfaction of agent preferences; and (c) enhanced quality of decision-making by validating decisions as satisfying global system requirements.

Exemplary embodiments for propagating information in collaborative decision-making are described above in detail. The computer-implemented systems and methods of operating such systems are not limited to the specific embodiments described herein, but rather, components of systems and/or steps of the methods may be utilized independently and separately from other components and/or steps described herein. For example, the methods may also be used in combination with other enterprise systems and methods, and are not limited to practice with only the collaborative decision-making systems and methods as described herein. Rather, the exemplary embodiment can be implemented and utilized in connection with many other enterprise applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A network-based computer-implemented system comprising:
a plurality of agent devices associated with a plurality of agents; and
a computing device in networked communication with said plurality of agent devices, said computing device including a processor and a memory device coupled to said processor, said computing device configured to:
a. receive decision-making criteria from at least one of at least a portion of said plurality of agents, said memory device, and a user;
b. generate valid decision combinations using at least a portion of received decision-making criteria;
c. transmit, to said plurality of agents, valid decision combinations;
d. receive, from a deciding agent, a decision;
e. constrain, using the received decision, valid decision combinations;
f. until determining that no more decisions can be received, return to c; and
g. upon determining that no more decisions can be received, transmit a final decision set to said plurality of agents, the final decision set representing a complete combination of decisions including at least a portion of received decisions.

2. The network-based computer-implemented system in accordance with claim 1, further configured to:
receive a plurality of decisions from a plurality of deciding agents; and
process the plurality of decisions by one of:
simultaneous processing; and
prioritizing the processing of the plurality of decisions based upon at least one of:
an order of receiving the plurality of decisions;
a priority ranking associated with each deciding agent; and
a priority ranking associated with each deciding agent given a system condition.

3. The network-based computer-implemented system in accordance with claim 1, wherein the decision-making criteria includes at least one of:
agent decision options associated with said agents;
agent decision relationships associated with said agents;
agent decision preferences associated with said agents; and
decision-making rules.

4. The network-based computer-implemented system in accordance with claim 1 further configured to determine that no more decisions can be received based upon one of:
no agents remaining that have not transmitted a decision;
a first critical time event occurring and decisions received by at least a quorum of said agents; and
a second critical time event occurring.

5. The network-based computer-implemented system in accordance with claim 1 further configured to:
determine that a final decision set cannot be generated based upon at least one of:
a change to decision-making criteria;
no remaining valid decision combinations; and
a received indication from at least one agent that the at least one agent rejects all remaining valid decision combinations; and
return to a.

6. The network-based computer-implemented system in accordance with claim 1 wherein a decision represents at least one of a singular decision and a group of decisions.

7. The network-based computer-implemented system in accordance with claim 1 further configured to transmit, to said plurality of agents, an assessment of outcomes for at least one decision combination, the assessment including at least one of:
a probability distribution of outcomes for each agent in each assessment;
outcomes of the at least one decisions ranked by at least one key performance indicator; and
outcomes based upon historic decision outcomes.

8. A computer-based method performed by a computing device, the computing device including a processor and a memory device coupled to the processor, said method comprising:
a. receiving decision-making criteria from at least one of at least a portion of a plurality of agents associated with a plurality of agent devices, the memory device, and a user;
b. generating valid decision combinations using at least a portion of received decision-making criteria;
c. transmitting, to the plurality of agents, valid decision combinations;
d. receiving, from a deciding agent, a decision;
e. constraining, using the received decision, valid decision combinations;
f. until determining that no more decisions can be received, returning to c; and
g. upon determining that no more decisions can be received, transmitting a final decision set to the plurality of agents, the final decision set representing a complete combination of decisions including at least a portion of received decisions.

9. The computer-based method in accordance with claim 8, further comprising:
receiving a plurality of decisions from a plurality of deciding agents; and
processing the plurality of decisions by one of:
simultaneous processing; and
prioritizing the processing of the plurality of decisions based upon at least one of:
an order of receiving the plurality of decisions;
a priority ranking associated with each deciding agent; and
a priority ranking associated with each deciding agent given a system condition.

10. The computer-based method in accordance with claim 8, wherein the wherein the decision-making criteria includes at least one of:
agent decision options associated with the agents;
agent decision relationships associated with the agents;
agent decision preferences associated with the agents; and
decision-making rules.

11. The computer-based method in accordance with claim 8, further comprising determining that no more decisions can be received based upon one of:
no agents remaining that have not transmitted a decision;
a first critical time event occurring and decisions received by at least a quorum of agents; and
a second critical time event occurring.

12. The computer-based method in accordance with claim 8, further comprising:
determining that a final decision set cannot be generated based upon at least one of:
a change to decision-making criteria;
no remaining valid decision combinations; and
a received indication from at least one agent that at the least one agent rejects all remaining valid decision combinations; and
return to a.

13. The computer-based method in accordance with claim 8, wherein a decision represents at least one of a singular decision and a group of decisions.

14. The computer-based method in accordance with claim 8, further comprising transmitting, to the plurality of agents, an assessment of outcomes for at least one decision combination, the assessment including at least one of:
a probability distribution of outcomes for each agent in each assessment;
outcomes of the at least one decisions ranked by at least one key performance indicator; and
outcomes based upon historic decision outcomes.

15. A computer including a processor and a memory device coupled to said processor, said computer configured to:
a. receive decision-making criteria from at least one of at least a portion of a plurality of agents associated with a plurality of agent devices, said memory device, and a user;
b. generate valid decision combinations using at least a portion of received decision-making criteria;
c. transmit, to the plurality of agents, valid decision combinations;
d. receive, from a deciding agent, a decision;
e. constrain, using the received decision, valid decision combinations;
f. until determining that no more decisions can be received, return to c; and
g. upon determining that no more decisions can be received, transmit a final decision set to the plurality of agents, the final decision set representing a complete combination of decisions including at least a portion of received decisions.

16. The computer of claim 15, further configured to:
receive a plurality of decisions from a plurality of deciding agents; and
process the plurality of decisions by one of:
simultaneous processing; and
prioritizing the processing of the plurality of decisions based upon at least one of:
an order of receiving the plurality of decisions;
a priority ranking associated with each deciding agent; and
a priority ranking associated with each deciding agent given a system condition.

17. The computer of claim 15, further configured to determine that no more decisions can be received based upon one of:
no agents remaining that have not transmitted a decision;
a first critical time event occurring and decisions received by at least a quorum of the agents; and
a second critical time event occurring.

18. The computer of claim 15 further configured to:
determine that a final decision set cannot be generated based upon at least one of:
a change to decision-making criteria;
a received indication from at least one agent that the at least one agent rejects all remaining valid decision combinations; and
no remaining valid decision combinations; and
return to a.

19. The computer of claim 15 wherein a decision represents at least one of a singular decision and a group of decisions.

20. The computer of claim 15, further configured to transmit, to the plurality of agents, an assessment of outcomes for at least one decision combination, the assessment including at least one of:
a probability distribution of outcomes for each agent in each assessment;
outcomes of the at least one decisions ranked by at least one key performance indicator; and
outcomes based upon historic decision outcomes.
